(19) United States
(12) Patent Application Publication
(10) Pub. No.: US 2023/0089162 A1
(43) Pub. Date: Mar. 23, 2023

(54) TRAINING DEVICE, TRAINING METHOD, AND TRAINING PROGRAM

(71) Applicant: Nippon Telegraph and Telephone Corporation, Tokyo (JP)

(72) Inventors: Jumpei Yamashita, Musashino-shi, Tokyo (JP); Hidetaka Koya, Musashino-shi, Tokyo (JP)

(21) Appl. No.: 17/798,355

(22) PCT Filed: Feb. 14, 2020
(86) PCT No.: PCT/JP2020/005912

§ 371 Date: Aug. 9, 2022

(51) Int. Cl. G06N 3/04; G06N 3/08

(52) U.S. Cl. CPC G06N 3/0454; G06N 3/084

(57) ABSTRACT

A learning apparatus (10) acquires a label corresponding to a variance not selectively explained by a latent variable, out of variances in characteristic of data. The learning apparatus (10) receives, as input data, real data or generated data output by a generator that generates data, discriminates whether the input data is the generated data or the real data, and adds, to a first neural network constituting a discriminator that estimates the latent variable, a path having two or more layers for estimating the label. The learning apparatus (10) performs learning for a second neural network obtained by adding the path so that by multiplying, by a minus sign, a gradient for an error propagating backward to the first neural network in a first layer of the added path during learning based on backpropagation, the gradient is propagated to minimize an estimation error for the latent variable, but the gradient is propagated to maximize an estimation error for the label.

### TECHNICAL FIELD

The present invention relates to a learning apparatus, a learning method, and a learning program.

### BACKGROUND ART

In the related art, there is a technique for expressing multi-dimensional data by latent variables with fewer dimensions to enable visualization of the data, and such a technique is available for behavioral analysis of people based on sensor data. There is a technique called Info-GAN obtained by developing an unsupervised learning framework called Generative Adversarial Network (GAN) having a generator and a discriminator each including a neural network and additionally using noise latent variables for explaining unestimated noise, in addition to latent variables estimated from data, thereby enabling estimation of the latent variables for generating data from the data.

It is further possible to visualize data converted into the latent variables by disentanglement for associating the dimensions of the latent variables with the dimensions of the data by using the Info-GAN, in a meaningful manner (see, for example, NPL 1).

### CITATION LIST

### Non Patent Literature

NPL 1: “InfoGAN: Interpretable Representation Learning by Information Maximizing Generative Adversarial Nets”, [online], GitHub, [Search on Feb. 4, 2020], the Internet <https://arxiv.org/abs/1606.03657>

### SUMMARY OF THE INVENTION

### Technical Problem

However, in the related art, there is a case where when multi-dimensional data is expressed on latent variables with fewer dimensions, a variance in certain characteristic desirably also appears correspondingly on the latent variables, but a variance in another characteristic undesirably appears correspondingly on the latent variables. Specifically, in processing sensor data (such as picked-up images, motion values acquired from an attached inertial sensor, and physiological signals acquired from an attached electrodes), it is very important to separate a variance in characteristic not due to an individual difference from a variance in characteristic due to an individual difference. However, a normal Info-GAN has a problem that all variances in characteristic of data are to be explained by latent variables.

### Means for Solving the Problem

In order to solve the problems described above and achieve an object, a learning apparatus according to the present invention includes an acquisition unit configured to acquire a label corresponding to a variance not selectively explained by a latent variable, out of variances in characteristic of data, an addition unit configured to receive, as input data, real data or generated data output by a generator configured to generate data, discriminate whether the input data is the generated data or the real data, and add, to a first neural network constituting a discriminator configured to estimate the latent variable, a path having two or more layers configured to estimate the label, and a learning unit configured to perform learning for a second neural network obtained by adding the path by the addition unit so that by multiplying, by a minus sign, a gradient for an error propagating backward to the first neural network in a first layer of the path during learning based on backpropagation, the gradient is propagated to minimize an estimation error for the latent variable, but the gradient is propagated to maximize an estimation error for the label.

### Effects of the Invention

The present invention exerts an effect of enabling appropriate learning by performing learning so that a variance not required to be considered is not explained by a latent variable.

### BRIEF DESCRIPTION OF DRAWINGS

FIG. 1 is a diagram for explaining Info-GAN.

FIG. 2 is a diagram for explaining a latent variable.

FIG. 3 is a diagram for explaining a latent variable.

FIG. 4 is a diagram for explaining a latent variable.

FIG. 5 is a diagram illustrating an example of a configuration of a learning apparatus according to a first embodiment.

FIG. 6 is a diagram illustrating a neural network obtained by adding a path having two or more layers to a neural network of a discriminator.

FIG. 7 is a diagram for explaining learning processing on the neural network of the discriminator.

FIG. 8 is a flowchart illustrating an example of the learning processing in the learning apparatus according to the first embodiment.

FIG. 9 is a diagram for explaining a data distribution on a latent variable.

FIG. 10 is a diagram for explaining a data distribution on a latent variable.

FIG. 11 is a diagram illustrating a computer that executes a learning program.

### DESCRIPTION OF EMBODIMENTS

An embodiment of a learning apparatus, a learning method, and a learning program according to the present application will be described below in detail with reference to the drawings. Note that the learning apparatus, the learning method, and the learning program according to the present application are not limited by the present embodiment.

### First Embodiment

In the following embodiment, an underlying technology of Info-GAN will be described first, and thereafter, a configuration of a learning apparatus 10 according to a first embodiment and a flowchart of processing of the learning apparatus 10 will be sequentially described, and finally, effects of the first embodiment will be described.

Info-GAN

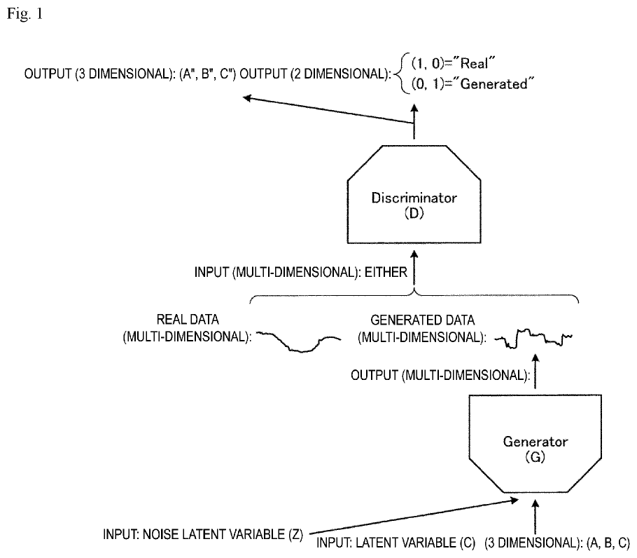

The Info-GAN will be described first with reference to FIG. 1. FIG. 1 is a diagram for explaining the Info-GAN. In the Info-GAN, a framework of GAN is evolved to enable estimation of a latent variable from data. Note that, in the following, a description is given using an example in which data is expressed with three-dimensional latent variables, but the number of dimensions is not limited to three.

As illustrated in FIG. 1, in a learning process, in addition to a latent variable estimated from data, some latent variables for explaining unestimated noise (hereinafter, these are referred to as “noise latent variables”) are additionally used.

A generator generates multi-dimensional data from the three-dimensional latent variables and the noise latent variables. A discriminator receives, as input, the data generated by the generator and real data, and discriminates whether the input data is the generated data or the real data. Additionally, the discriminator estimates from which latent variable the generated data is generated.

In learning of the generator, an evaluation function is determined in which the accuracy of a result obtained by causing the discriminator to discriminate between the data generated by the generator and the real data reduces, and the accuracy of a result obtained by causing the discriminator to estimate from which latent variable the data generated by the generator is generated improves.

In learning of the discriminator, an evaluation function is determined in which the accuracy of a result obtained by causing the discriminator to discriminate between the data generated by the generator and the real data improves, and the accuracy of a result obtained by causing the discriminator to estimate from which latent variable the data generated by the generator is generated improves.

Successful learning allows the generator to generate data indistinguishable from the real data, and does not allow the discriminator to completely distinguish the generated data from the real data. At the same time, the discriminator can estimate from which latent variable the generated data is generated. At this time, it is possible to interpret that a process in which data is generated from latent variables is modeled in the generator.

Additionally, it is possible to interpret that if another model estimates a latent variable from the generated data, the process in which data is generated is modeled to facilitate the estimation (mutual information amount between the latent variable and the generated data is maximized). This allows the discriminator to estimate from which latent variable the generated data is generated. When real data is input into such a discriminator, it is possible to estimate a latent variable for generating the data.

Next, the three-dimensional latent variables will be described. For example, a generative process is considered in which three continuous latent variables (A, B, and C) according to a probability distribution are prepared, and when a combination of values of the latent variables is input into a model, data is output. At this time, if it is possible to express a majority of a variance in characteristic for each data by a change in value of each of the latent variable A, the latent variable B, and the latent variable C and a combination thereof, it is possible to interpret that a process in which sensor data is generated from the three latent variables is successfully modeled.

If multi-dimensional data is expressed by latent variables with fewer dimensions by using the above-described Info-GAN, it is possible to visualize the data. An example of a promising method for visualizing the data includes disentanglement. The disentanglement is to associate the dimension of a latent variable with the dimension of data.

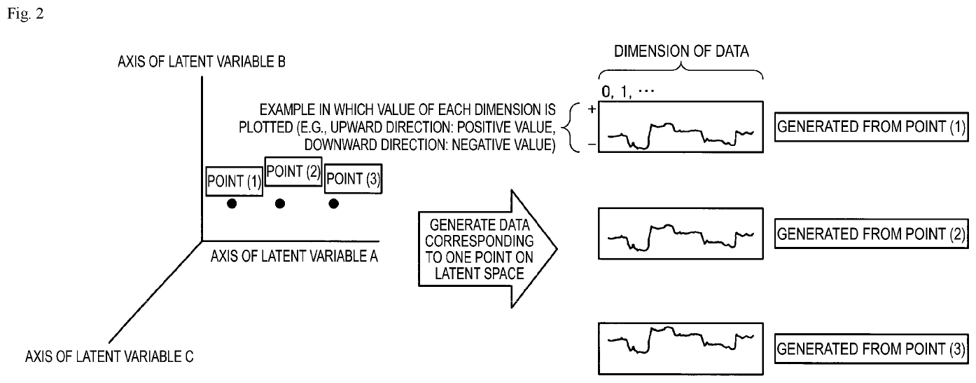

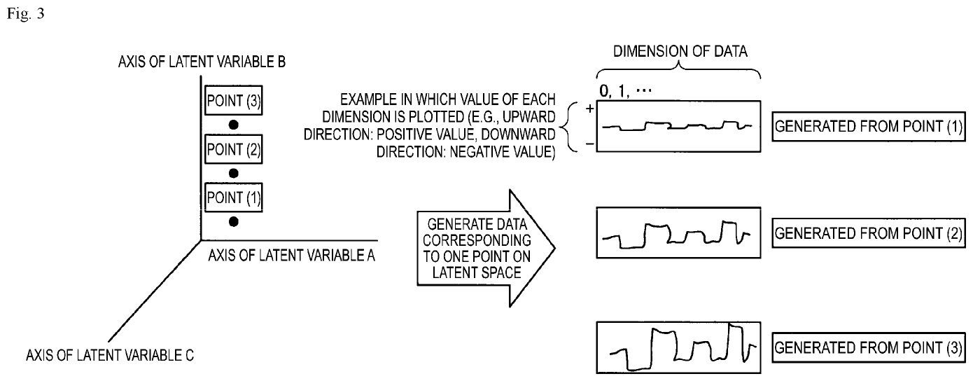

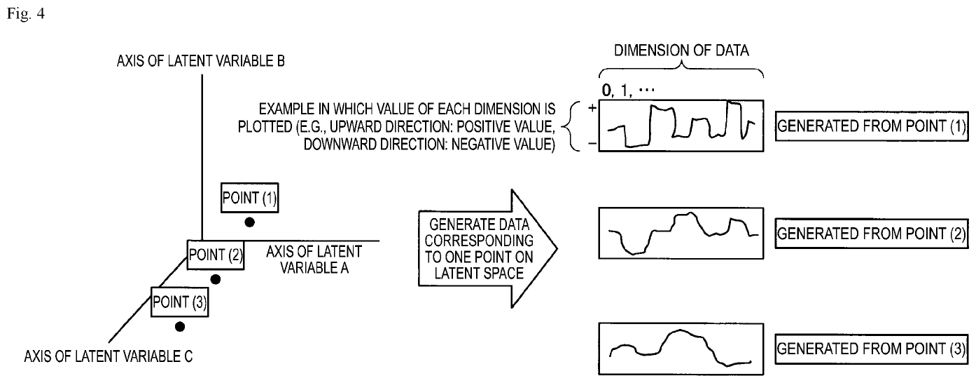

The association of the dimension of a latent variable with the dimension of data has the following meaning. For example, as illustrated in FIG. 2, if the latent variable A is moved, an average value of the data moves. For example, as illustrated in FIG. 3, if the latent variable B is moved, distribution of the data changes. For example, as illustrated in FIG. 4, if the latent variable C is moved, whether a manner in which the data changes is continuous changes.

That is, in the disentanglement, a process in which data is generated from latent variables is learned so that each of the latent variables has an “interpretable meaning” with respect to variances in characteristic in the data. As a result, in the disentanglement, it is possible to express multi-dimensional data on interpretable fewer dimensions. For example, with such a method, it is possible to visualize data converted into latent variables in a meaningful manner.

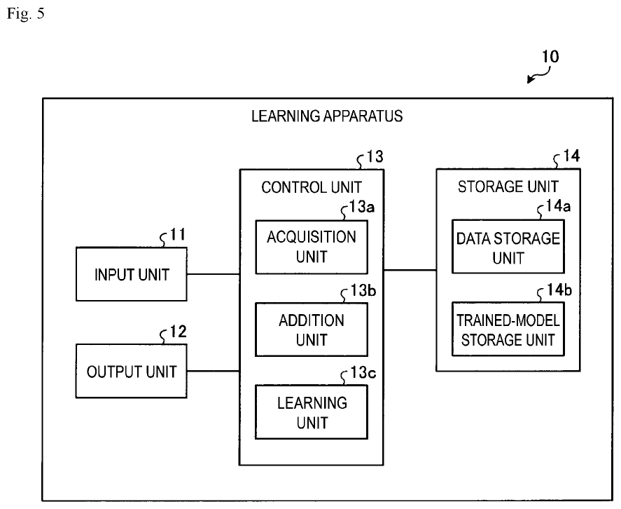

Configuration of Learning Apparatus Next, a configuration of the learning apparatus 10 will be described with reference to FIG. 5. FIG. 5 is a diagram illustrating an example of the configuration of the learning apparatus according to the first embodiment. As illustrated in FIG. 5, the learning apparatus 10 executes the above learning based on the Info-GAN so that a difference not required to be considered is not explained by a latent variable.

As illustrated in FIG. 1, the learning apparatus 10 includes an input unit 11, an output unit 12, a control unit 13, and a storage unit 14. Each unit will be described below.

The input unit 11 is achieved by using an input device such as a keyboard or a mouse and inputs various types of instruction information such as processing start to the control unit 13 in response to an input operation from an operator. The output unit 12 is achieved by a display device such as a liquid crystal display, a printing device such as a printer, or the like.

The storage unit 14 is achieved by a semiconductor memory element such as a random access memory (RAM) or a flash memory or a storage apparatus such as a hard disk or an optical disk, and a processing program for causing the learning apparatus 10 to operate, data used during execution of the processing program, and the like are stored in the storage apparatus. The storage unit 14 includes a data storage unit 14a and a trained-model storage unit 14b.

The data storage unit 14a stores various types of data for use during learning. For example, the data storage unit 14a stores data acquired from a sensor worn by a user as real data for use during learning. Note that the various types of data may include any data as long as such data includes a plurality of real values, such as a rearranged signal acquired from an electrode worn by the user, and data of a captured image.

The trained-model storage unit 14b stores a trained model trained by learning processing described below. For example, the trained-model storage unit 14b stores, as the trained model, the generator and the discriminator each including a neural network. The generator generates multi-dimensional data from three-dimensional latent variable and noise latent variables. The discriminator receives, as input, the data generated by the generator and real data. The discriminator discriminates whether the input data is the generated data or the real data. The discriminator also estimates from which latent variable the generated data is generated.

The control unit 13 includes an internal memory for storing programs that define various processing procedures and the like and required data, and executes various types of processing using the programs and the data. For example, the control unit 13 is an electronic circuit such as a central processing unit (CPU) or a micro processing unit (MPU). The control unit 13 includes an acquisition unit 13a, an addition unit 13b, and a learning unit 13c.

The acquisition unit 13a acquires a label corresponding to a variance not selectively explained by a latent variable, out of variances in characteristic of data. Note that the label is prepared in advance at a data preparation stage. For example, a label corresponding to a variance desired to be not considered due to an individual difference is set.

To explain a specific example, for example, if a difference in behavior is to be explained by an explanatory variable without considering to whom the data belongs, a number for identifying an individual wearing a sensor is prepared as a label for each of all multi-dimensional data to be visualized.

The additional unit 13b receives, as input data, generated data output by a generator that generates data or real data, and discriminates whether the input data is the generated data or the real data. At the same time, the addition unit 13b adds, to a first neural network constituting a discriminator that estimates a latent variable, a path having two or more layers for estimating a label. Note that the path means a node and an edge included in a neural network, or the edge.

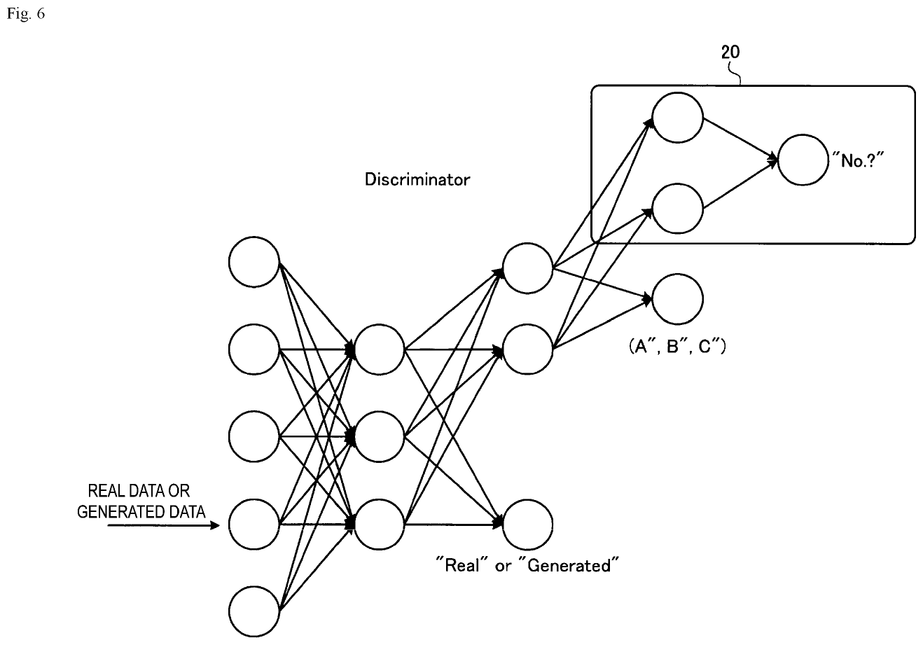

For example, as illustrated in FIG. 6, the addition unit 13b adds, to the discriminator of the Info-GAN, a path 20 having two or more layers for estimating what “a label corresponding to a variance desired to be not considered due to an individual difference” of the input data is. That is, the addition unit 13b adds a path for estimating “to whom the input data belongs”, for example, as a path newly branched from a root of the path for estimating the “latent variable” in the neural network serving as the discriminator.

Regarding a second neural network obtained by adding the path by the addition unit 13b, the learning unit 13c multiplies, by a minus sign, a gradient for an error propagating backward to the first neural network in a first layer of the path during learning based on the backpropagation. As a result, the learning unit 13c performs learning so that the gradient is propagated to minimize an estimation error for the latent variable and the gradient is propagated to maximize an estimation error for the label.

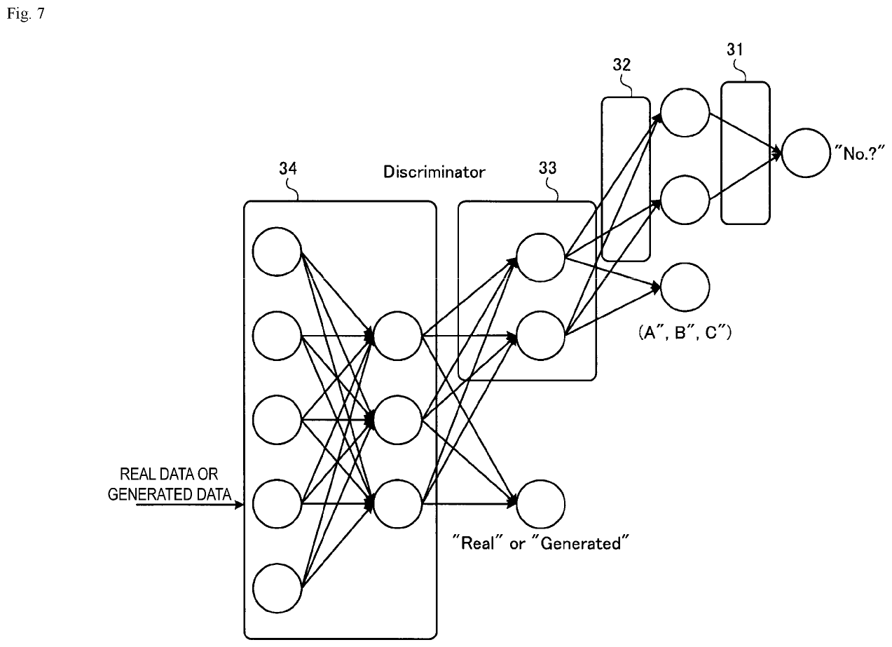

For example, the learning unit 13c uses a connection weight at the root portion of the added path to multiply, by a minus sign, the propagating error during learning based on the backpropagation. Such a connection weight is fixed and is not subject to learning. Note that how the error from the added path is handled is as follows. That is, the estimation error for the label is propagated up to a path for estimating a latent variable C (a path 33 in FIG. 7), but the estimation error for the label is not propagated up to a portion (a path 34 in FIG. 7) joined with a path for discriminating between real data and generated data in the preceding layer.

Here, FIG. 7 is a diagram for explaining learning processing on the neural network of the discriminator. In an example of FIG. 7, in a path 32, a connection weight is not subject to learning. The learning unit 13c performs learning so that a path 31 estimates “whose sensor data is the input data?” in the added path, by using information about “who is that person?” included in an output of a result obtained by processing the input real data in the path 33 and the path 34.

On the other hand, the learning unit 13c multiplies, by a minus sign, an error propagating backward to the path 33 in the path 32 during learning based on the backpropagation, and thus, the learning unit 13c performs learning of the path 33 (not allowing the error to be propagated in any path before the path 34) so that “the accuracy of estimation by the path 31 regarding ‘whose sensor data is the input data?’ decreases”. That is, the path 33 is made to output a result in which information regarding “whose sensor data is this?” included in the data processed by the path 34 is eliminated as much as possible.

With such learning, the path 33 is made to output a result in which information regarding “whose data is this?” is eliminated in response to an input. For example, if the latent variable c explains “whose data is this?”, this elimination causes the discriminator not to estimate the latent variable c, and as a result, the estimation error increases. Thus, the generator is made to acquire, as a model, a process in which data is generated so that the latent variable does not explain a difference not required to be considered (it is thought that such a difference is to be explained by a noise latent variable z instead of the latent variable c). With the operations described above, it is possible to optionally select whether a variance in characteristic is to be included in the latent variable c.

The learning unit 13c may set a value of 1 or less as an initial value of the connection weight in the first layer of the added path to increase or decrease the connection weight at every time of the learning. The learning unit 13c sets a value of 1 or less as an initial value of the connection weight in the first layer of the added path to increase or decrease the connection weight at every time of the learning, so that it is possible to adjust a pace for eliminating information for a portion not selectively explained within the discriminator. Note that an example is provided where the initial value is 1 or less, but values outside such a range may be freely set as necessary.

After learning of the Info-GAN, the learning unit 13c stores the trained model in the trained-model storage unit 14b. The learning apparatus 10 may visualize data if the learning apparatus 10 uses the trained model to express multi-dimensional data by latent variables with fewer dimensions. For example, the learning apparatus 10 may further have a function of visualizing and analyzing data with reduced dimensions by using the trained model, and a function of creating content while analyzing such data. Another apparatus may utilize the trained model of the learning apparatus 10.

Processing Procedure of Learning Apparatus

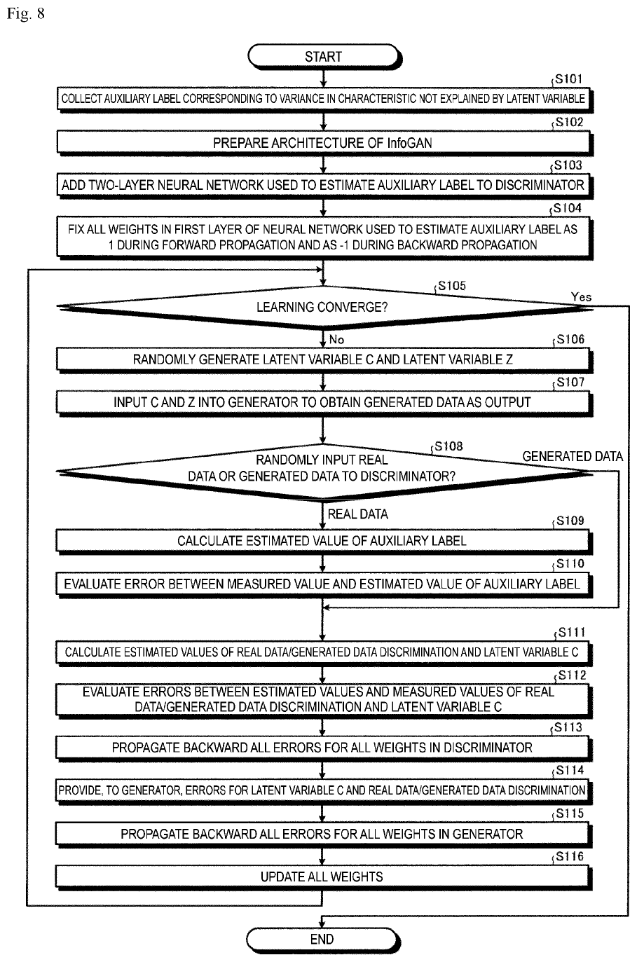

Next, an example of a processing procedure performed by the learning apparatus 10 according to the first embodiment will be described with reference to FIG. 8. FIG. 8 is a flowchart illustrating an example of a flow of the learning processing in the learning apparatus according to the first embodiment.

As illustrated in FIG. 8, the acquisition unit 13a of the learning apparatus 10 collects a label (auxiliary label) corresponding to a variance in characteristic not explained by a latent variable (step S101). The learning apparatus 10 prepares an architecture of the Info-GAN (step S102), and adds, to the discriminator, a two-layer neural network used for estimation of the auxiliary label (step S103).

The learning apparatus 10 fixes all weights in a first layer of the neural network used for the estimation of the auxiliary label to 1 during forward propagation and to −1 during backward propagation (step S104).

Thereafter, the learning apparatus 10 determines whether the learning converges (step S105), and if the learning apparatus 10 determines that the learning does not converge (No in step S105), the learning apparatus 10 randomly generates a latent variable c and a latent variable z (step S106). The learning apparatus 10 inputs c and z into the generator, obtains generated data as an output (step S107), and randomly inputs real data or the generated data into the discriminator (step S108).

If the learning apparatus 10 inputs the real data into the discriminator, the learning apparatus 10 calculates an estimated value of the auxiliary label (step S109), evaluates an error between a measured value and the estimated value of the auxiliary label (step S110), and the processing proceeds to step S111. If the learning apparatus 10 inputs the generated data into the discriminator, the processing proceeds to step S111.

The learning apparatus 10 calculates estimated values of real data/generated data discrimination and the latent variable c (step S111), and evaluates errors between the estimated values and the measured values of the real data/generated data discrimination and the latent variable c (step S112).

Subsequently, the learning apparatus 10 propagates backward all errors for all weights in the discriminator (step S113), and provides the errors for the real data/generated data discrimination and the latent variable c to the generator (step S114). The learning apparatus 10 propagates backward all the errors for all the weights within the generator (step S115), updates all the weights (step S116), and the processing returns to step S105.

The learning apparatus 10 repeatedly performs the processing in steps S105 to S116 until the learning converges, and if the learning converges (Yes in step S105), the processing of the present flowchart ends.

Effects of First Embodiment

Thus, the learning apparatus 10 according to the first embodiment acquires a label corresponding to a variance not selectively explained by a latent variable, out of variances in characteristic of data. The learning apparatus 10 receives, as input data, generated data output by the generator that generates data or real data, discriminates whether the input data is the generated data or the real data, and adds, to the first neural network constituting the discriminator that estimates the latent variable, a path having two or more layers for estimating the label. Regarding a second neural network obtained by adding the path, the learning apparatus 10 multiplies, by a minus sign, a gradient for an error propagating backward to the first neural network in a first layer of the path during learning based on the backpropagation. As a result, the learning apparatus 10 performs the learning so that the gradient is propagated to minimize an estimation error for the latent variable and the gradient is propagated to maximize an estimation error for the label.

As a result, the learning apparatus 10 according to the first embodiment performs learning so that a variance not required to be considered is not explained by a latent variable, and thus, it is possible to model a generative process in which only a desired variance in characteristic is explained by the latent variable c to appropriately perform the learning.

That is, in the learning apparatus 10, for example, a label corresponding to a variance desired to be not considered due to an individual difference is prepared at a data preparation stage, and the discriminator of the Info-GAN is added with a path having two or more layers for estimating what is the “label corresponding to a variance desired to be not considered due to an individual difference” of the input data. During learning based on the backpropagation, the learning apparatus 10 uses a connection weight at the root portion of the added path to multiply, by a minus sign, the gradient for the propagated error, and as a result, the connection weight is fixed and is not subject to learning. Note that, for the error from the added path, the estimation error for the label is propagated up to the added path for estimating the latent variable C (the path 33 in FIG. 7), but the estimation error for the label is not propagated up to a portion (the path 34 in FIG. 7) joined with the path for discriminating between real data and generated data in the preceding layer. Thus, in the learning apparatus 10, it is possible to perform appropriate learning with dimensionality reduction according to the intended meaning.

The related-art Info-GAN has a problem that all variances in characteristic of data are to be explained by a latent variable. Thus, in dimensionality reduction using a related-art manner, the latent variable c is selected to be meaningful with respect to both a difference that is a “difference provided in common to each person (here, behavior in an example) and a difference in “person”. In the related-art Info-GAN, if it is desired to express only a desired variance of an individual difference and a behavioral difference, it is not possible to perform the learning so that a difference not required to be considered is not explained by the latent variable.

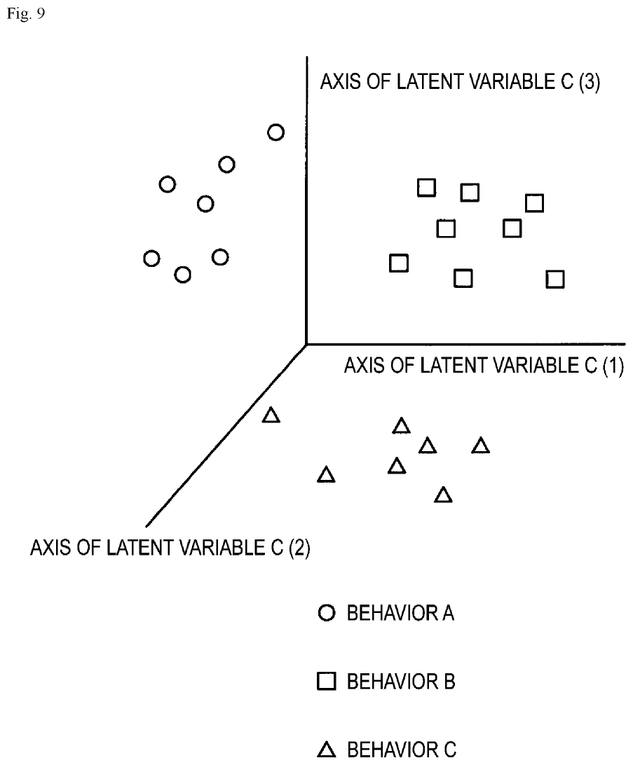

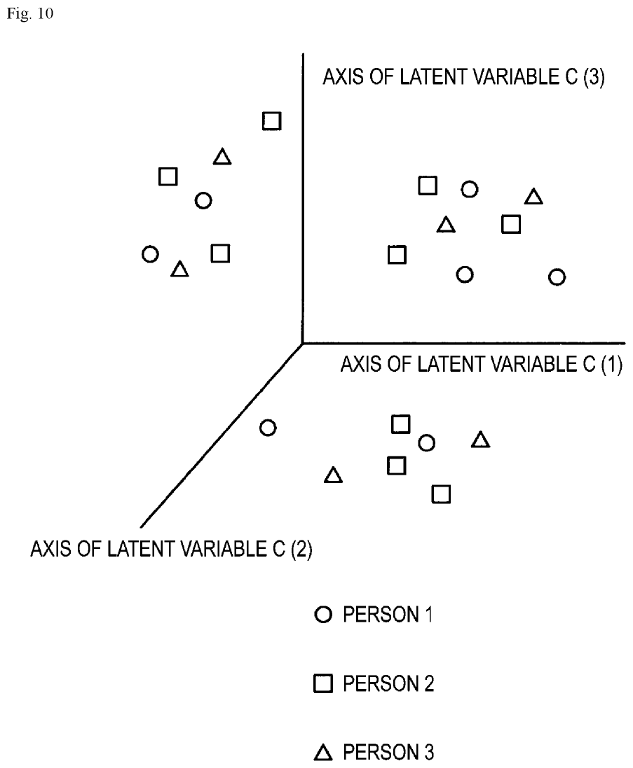

In the learning apparatus 10 according to the first embodiment, if the “difference in behavior” is explained by three latent variables, it is possible to select the latent variable c so that a variance in characteristic of data for the difference in “behavior” is explained. On the other hand, a variance in characteristic of data for the difference in “person” is not explained. To provide a specific visual image, a data distribution as illustrated in FIG. 9 and FIG. 10, for example, is obtained on a latent variable space. FIG. 9 and FIG. 10 are diagrams for explaining a data distribution on the latent variable space. That is, in sensor data, visualization is often desired regardless of to whom data belongs (it is desired to analyze a difference occurring in common to each person such as behavior and a situation instead of an individualistic difference). The learning apparatus 10 performs learning, in such a case, so that only a difference desired to be considered is explained and a difference desired to be not considered such as an individual difference is not explained by a latent variable, and thus, it is possible to visualize only a variance in characteristic not due to the individual difference.

System Configuration and the Like

In addition, constituent components of the devices illustrated in the drawings are functionally conceptual and are not necessarily physically configured as illustrated in the drawings. That is, the specific aspects of distribution and integration of each device are not limited to those illustrated in the drawings, and all or some of the devices may be distributed or integrated functionally or physically in desired units depending on various kinds of loads, states of use, and the like. Further, all or some of the processing functions performed by the devices can be implemented by a CPU and a program analyzed and executed by the CPU or implemented as hardware with wired logic.

In addition, all or some of the processing operations described as being automatically performed among the processing operations described in the present embodiment may be performed manually, or all or some of the processing operations described as being manually performed may be performed automatically using a known method. In addition, the processing procedures, control procedures, specific names, and information including various types of data or parameters described in the above document or drawings can be freely changed unless otherwise specified.

Program

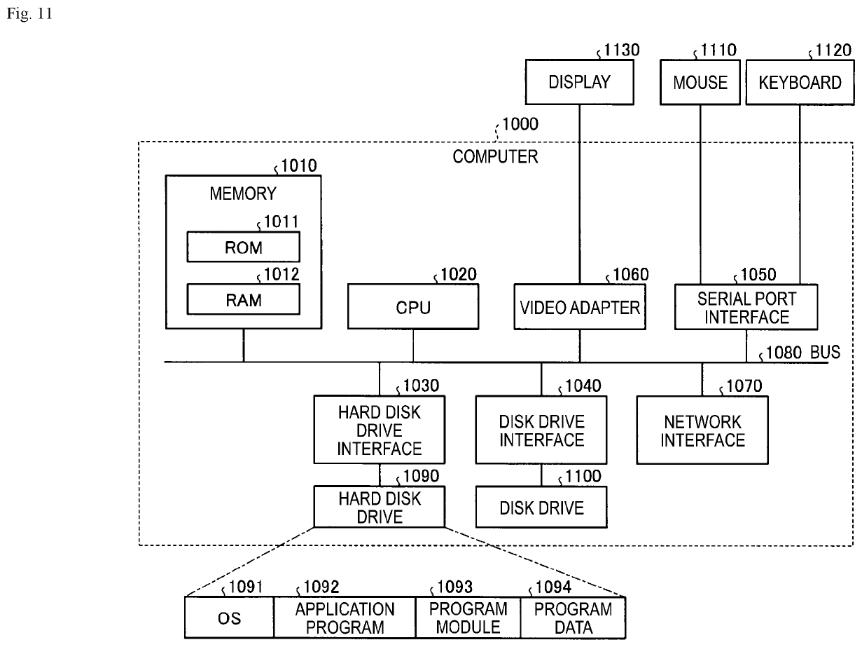

FIG. 11 is a diagram illustrating a computer that executes a learning program. A computer 1000 includes, for example, a memory 1010 and a CPU 1020. Further, the computer 1000 includes a hard disk drive interface 1030, a disc drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium such as, for example, a magnetic disc or an optical disc is inserted into the disc drive 1100. The serial port interface 1050 is connected to, for example, a mouse 1051 and a keyboard 1052. The video adapter 1060 is connected to, for example, a display 1061.

The hard disk drive 1090 stores, for example, an OS 1091, an application program 1092, a program module 1093, and program data 1094. In other words, a program defining each processing of the learning apparatus is implemented as the program module 1093 in which a code executable by the computer is described. The program module 1093 is stored in, for example, the hard disk drive 1090. For example, the program module 1093 for executing the same processing as that performed by the functional configurations in the apparatus is stored in the hard disk drive 1090. Further, the hard disk drive 1090 may be replaced with a solid state drive (SSD).

In addition, data used for the processing of the above-described embodiment is stored as the program data 1094 in, for example, the memory 1010 or the hard disk drive 1090. In addition, the CPU 1020 reads out and executes the program module 1093 or the program data 1094 stored in the memory 1010 or the hard disk drive 1090, as necessary, in the RAM 1012.

The program module 1093 and the program data 1094 are not necessarily stored in the hard disk drive 1090, and may be stored in, for example, a removable storage medium and be read out by the CPU 1020 through the disc drive 1100 or the like. Alternatively, the program module 1093 and the program data 1094 may be stored in another computer connected via a network or a WAN. The program module 1093 and the program data 1094 may be read from another computer via the network interface 1070 by the CPU 1020.

### REFERENCE SIGNS LIST

10 Learning apparatus
11 Input unit
12 Output unit
13 Control unit
13a Acquisition unit
13b Addition unit
13c Learning unit
14 Storage unit
14a Data storage unit
14b Trained-model storage unit

1. A learning apparatus, comprising:
an acquisition unit, including one or more processors, configured to acquire a label corresponding to a variance not selectively explained by a latent variable, out of variances in characteristic of data;
an addition unit, including one or more processors, configured to receive, as input data, real data or generated data output by a generator configured to generate data, discriminate whether the input data is the generated data or the real data, and add, to a first neural network constituting a discriminator configured to estimate the latent variable, a path having two or more layers configured to estimate the label; and
a learning unit, including one or more processors, configured to perform learning for a second neural network obtained by adding the path by the addition unit so that by multiplying, by a minus sign, a gradient for an error propagating backward to the first neural network in a first layer of the path during learning based on backpropagation, the gradient is propagated to minimize an estimation error for the latent variable, but the gradient is propagated to maximize an estimation error for the label.

2. The learning apparatus according to claim 1, wherein the learning unit is configured to set an initial value to a connection weight in the first layer, and increase or decreases the connection weight at every time of learning.

3. The learning apparatus according to claim 1, wherein the acquisition unit is configured to acquire a label corresponding to a variance desired to be not considered due to an individual difference as a variance not selectively explained by a latent variable, out of variances in characteristic of sensor data.

4. A learning method executed by a learning apparatus, comprising:
acquiring a label corresponding to a variance not selectively explained by a latent variable, out of variances in characteristic of data;
receiving, as input data, real data or generated data output by a generator configured to generate data, discriminating whether the input data is the generated data or the real data, and adding, to a first neural network constituting a discriminator configured to estimate the latent variable, a path having two or more layers configured to estimate the label; and
performing learning for a second neural network obtained by adding the path in the adding so that by multiplying, by a minus sign, a gradient for an error propagating backward to the first neural network in a first layer of the path during learning based on backpropagation, the gradient is propagated to minimize an estimation error for the latent variable, but the gradient is propagated to maximize an estimation error for the label.

5. A non-transitory computer-readable storage medium storing a learning program causing a computer to execute:
acquiring a label corresponding to a variance not selectively explained by a latent variable, out of variances in characteristic of data;
receiving, as input data, real data or generated data output by a generator configured to generate data, discriminating whether the input data is the generated data or the real data, and adding, to a first neural network constituting a discriminator configured to estimate the latent variable, a path having two or more layers configured to estimate the label; and
performing learning for a second neural network obtained by adding the path in the adding so that by multiplying, by a minus sign, a gradient for an error propagating backward to the first neural network in a first layer of the path during learning based on backpropagation, the gradient is propagated to minimize an estimation error for the latent variable, but the gradient is propagated to maximize an estimation error for the label.

6. The learning method according to claim 4, further comprising:
setting an initial value to a connection weight in the first layer, and increasing or decreases the connection weight at every time of learning.

7. The learning method according to claim 4, further comprising:
acquiring a label corresponding to a variance desired to be not considered due to an individual difference as a variance not selectively explained by a latent variable, out of variances in characteristic of sensor data.

8. The non-transitory computer-readable storage medium according to claim 5, wherein the stored learning program further causes the computer to execute:
setting an initial value to a connection weight in the first layer, and increasing or decreases the connection weight at every time of learning.

9. The non-transitory computer-readable storage medium according to claim 5, wherein the stored learning program further causes the computer to execute:
acquiring a label corresponding to a variance desired to be not considered due to an individual difference as a variance not selectively explained by a latent variable, out of variances in characteristic of sensor data.
